(19) United States
(12) Patent Application Publication
(10) Pub. No.: US 2024/0388207 A1
(43) Pub. Date: Nov. 21, 2024

(54) ISOLATED SWITCHING CONVERTER WITH ADAPTIVE DRIVING STRENGTH AND CONTROL METHOD THEREOF

(71) Applicant: Chengdu Monolithic Power Systems Co., Ltd., Chengdu (CN)

(72) Inventor: Siran Wang, Hangzhou (CN)

(21) Appl. No.: 18/665,464

(22) Filed: May 15, 2024

(30) Foreign Application Priority Data
May 19, 2023 (CN) 202310573510.7

(51) Int. Cl. H02M 3/335; H02M 1/08

(52) U.S. Cl. CPC H02M 3/33507; H02M 1/08

(57) ABSTRACT

A controller used in an isolated switching converter having a transformer and a primary switch, the controller has a gate driver to provide a driving control signal for driving the primary switch. The gate driver receives information indicating a mode of operation of the isolated switching converter. The driving control signal is controlled to being switchable between a first driving strength and a second driving strength based on the information. When the isolated switching converter operates in a continuous conduction mode, the driving control signal is controlled to have the first driving strength, and when the isolated switching converter operates in a discontinuous conduction mode, the driving control signal is controlled to have the second driving strength stronger than the first driving strength.

### CROSS-REFERENCE TO RELATED APPLICATIONS

This application claims the benefit of CN application 202310573510.7, filed on May 19, 2023, and incorporated herein by reference.

### TECHNICAL FIELD OF THE INVENTION

The present invention generally relates to electronic circuits, and more particularly but not exclusively, to a controller used in an isolated switching converter with adaptive driving strength and associated control methods.

### BACKGROUND OF THE INVENTION

Many loads, such as printers or cell phone chargers, have varied power demands depending on the particular function being performed. Most of the functions have low to mid power demands and can be performed by conventional isolated switching converters. Such low to mid power demands are referred to as normal operation. Some other functions, such as the paper scrolling function of a printer that requires use of a motor, have high or peak power demands that exceed the effective range of the conventional isolated switching converters with normal operation. The peak power demand of the switching converter may fluctuate from 100% to 400% of the normal operation. Meanwhile, such fluctuations may occur in a relatively short time duration, compared to the entire working process.

For the scenario where the high power demand lasts for such short time duration, one prior solution is to increase design capacity of the switching converter to accommodate the extra power demand under all operating conditions. Another traditional solution is to increase the switching frequency of the switching converter. However, increasing capacity to the design usually results in a larger, more expensive switching converter. Increasing the switching frequency of the switching converter introduces the amount of unwanted electromagnetic interference. In addition, increasing the switching frequency may reduce the overall efficiency of the switching converter and also lead to an unintended increase in the heat generated by the switching converter.

### SUMMARY OF THE INVENTION

An embodiment of the present invention discloses a controller used in an isolated switching converter having a transformer and a primary switch. The controller has a gate driver. The gate driver provides a driving control signal for driving the primary switch. The gate driver receives information indicating a mode of operation of the isolated switching converter. The driving control signal is controlled to being switchable between a first driving strength and a second driving strength based on the information. When the isolated switching converter operates in a continuous conduction mode, the driving control signal is controlled to have the first driving strength, and when the isolated switching converter operates in a discontinuous conduction mode, the driving control signal is controlled to have the second driving strength stronger than the first driving strength.

Another embodiment of the present invention discloses an isolated switching converter. The isolated switching converter has a transformer having a primary winding and a secondary winding, and a primary switch coupled to the primary winding, and a controller having a gate driver. The gate driver provides a driving control signal for driving the primary switch and receives information indicating a mode of operation of the isolated switching converter. The driving control signal is controlled to being switchable between a first driving strength and a second driving strength based on the information. When the isolated switching converter operates in CCM, the driving control signal is controlled to have the first driving strength, and when the isolated switching converter operates in DCM, the driving control signal is controlled to have the second driving strength stronger than the first driving strength.

Yet another embodiment of the present invention discloses a control method used in an isolated switching converter having a transformer and a primary switch. The control method has the following steps. A driving control signal for driving the primary switch is provided. The driving control signal has at least one driving parameter. Information indicating a mode of operation of the isolated switching converter is received. Based on the information, the at least one parameter is determined to control the driving control signal being switchable between a first driving strength and a second driving strength. The drive control signal having the determined driving parameter is applied to a control terminal of the primary switch. When the isolated switching converter operates in CCM, the driving control signal is controlled to have the first driving strength, and when the isolated switching converter operates in DCM, the driving control signal is controlled to have the second driving strength stronger than the first driving strength.

### BRIEF DESCRIPTION OF DRAWINGS

The present invention can be further understood with reference to the following detailed description and the appended drawings, wherein like elements are provided with like reference numerals.

FIG. 1 shows a block circuit diagram of an isolated switching converter 100 in accordance with an embodiment of the present invention.

FIG. 2 shows a schematic diagram of a gate driver 102A in accordance with an embodiment of the present invention.

FIG. 3A shows a working waveform of the gate driver 102A shown in FIG. 2 in accordance with an embodiment of the present invention.

FIG. 3B shows a working waveform of the gate driver 102A shown in FIG. 2 in accordance with another embodiment of the present invention.

FIG. 4 shows a schematic diagram of an isolated switching converter 100A in accordance with an embodiment of the present invention.

FIG. 5 shows a schematic diagram of an isolated switching converter 100B in accordance with an embodiment of the present invention.

FIG. 6 shows working waveforms of a primary ON enable signal under normal operation and a peak power mode in accordance with an embodiment of the present invention.

FIG. 7 shows a circuit diagram of an error amplifying circuit 104A and a peak power detection circuit 105A in accordance with an embodiment of the present invention.

FIG. 8 shows a flow diagram of a control method 600 used in an isolated switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

The present invention can be used in any isolated switching converter. In the following detailed description, for the sake of brevity, only a flyback converter is taken as an example to explain and describe the working principle of the present invention.

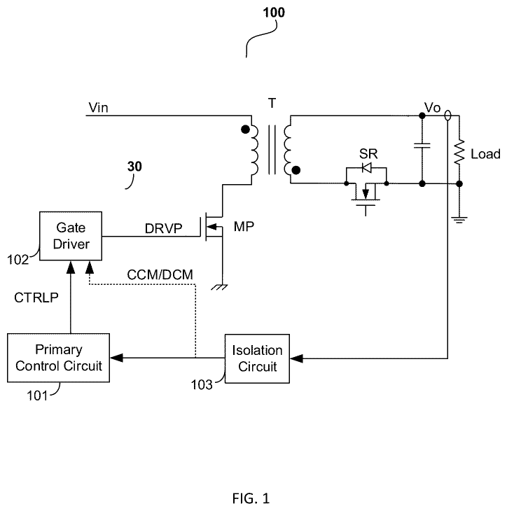

FIG. 1 shows a block circuit diagram of an isolated switching converter 100 in accordance with an embodiment of the present invention. As shown in FIG. 1, the isolated switching converter 100 comprises a transformer T, a primary switch MP, a secondary switch SR, and a controller 30. The controller 30 comprises a primary control circuit 101, a gate driver 102 and an isolation circuit 103. The transformer T has a primary winding and a secondary winding. The primary winding and the secondary winding both have a first terminal and a second terminal. The first terminal of the primary winding receives an input voltage Vin, the first terminal of the secondary winding provides a DC output voltage Vo, and the second terminal of the secondary winding is coupled to a secondary reference ground. The primary switch MP is coupled between the second terminal of the primary winding and a primary reference ground. The secondary switch SR is coupled between the second terminal of the secondary winding and a load. However, those skilled in the art should know that the secondary switch SR may also be coupled between the first terminal of the secondary winding and the load.

In one embodiment, the primary switch MP may be any controllable semiconductor devices, such as a MOSFET (Metal Oxide Semiconductor Field Effect Transistor), a SiC (Silicon Carbide), a GaN (Gallium Nitride) and so on. The primary switch MP has a first terminal, a second terminal and a control terminal. Based on a driving control signal DRVP applied to the control terminal of the primary switch MP, the electrical connection between a first terminal of the primary switch MP and the second terminal of a second terminal of the primary switch MP is controlled.

For the sake of brevity, the term “gate” is used herein to refer to the control terminal of the primary switch MP (e.g., a gate of a MOSFET, a gate of a SiC, a gate of a GaN and/or the like). The gate of the primary switch MP may behave as a capacitor. When the gate driver 102 is connected to the gate of the primary switch MP, the gate is charged to allow a current to flow between the first terminal of the primary switch MP and the second terminal of the primary switch MP. The speed at which the gate is charged, i.e., the speed at which the gate current and voltage are made available, may be dependent on a driving strength of the gate driver 102.

In one embodiment, the gate driver 102 is configured to provide the driving control signal DRVP to drive the primary switch MP. The gate driver 102 is configured to receive information indicating a mode of operation of the isolated switching converter 100. Based on the information, the gate driver 102 controls the driving control signal DRVP being switchable between a first driving strength and a second driving strength. The first driving strength is weaker than the second driving strength. Wherein the mode of operation of the isolated switching converter 100 could be a continuous conduction mode (CCM) or a discontinuous conduction mode (DCM). In response to operating in CCM of the switching converter 100, the driving control signal DRVP is controlled and switched to have the first driving strength. And in response to operating in DCM of the isolated switching converter 100, the driving control signal DRVP is controlled and switched to have the second driving strength. In one embodiment, the first driving strength may refer to a minimum voltage level and/or a minimum current level that is used to drive the gate to operate the primary switch MP. The second driving strength may refer to a maximum voltage and current levels that is used to drive the gate to operate the primary switch MP.

In one embodiment, the driving control signal DRVP may have one or more driving parameters. The driving strength of the driving control signal DRVP may depend on the one or more driving parameters performed by electrical circuits of the gate driver 102 connected to the gate of the primary switch MP. The one or more driving parameters may comprise, for example, a gate driving current, a gate driving voltage, a rising slope, a rising time, a gate driver impedance, and/or gate driving pulse, and so on. In one embodiment, the drive control signal DRVP is switched to have the first drive strength by adjusting one driving parameter to be a minimum value, and the drive control signal DRVP is switched to have the second driving strength by adjusting the one driving parameter to be a maximum value.

In the embodiment shown in FIG. 1, the primary control circuit 101 is configured to provide a primary control signal CTRLP to control the primary switch MP. In one embodiment, the primary switch MP is turned on in response to a first level of the primary control signal CTRLP, and the primary switch MP is turned off in response to a second level of the primary control signal CTRLP. A current flowing through the primary winding is generated when the primary switch MP is turned on, and no current is generated when the primary switch MP is turned off. In the embodiment shown in FIG. 1. the gate driver 102 is configured to receive the primary control signal CTRLP and to provide the driving control signal DRVP associated with the primary control signal CTRLP for driving the primary switch MP.

In one embodiment, the isolated switching converter 100 further comprises a mode detection circuit (not shown). The mode detection circuit is configured to detect if the isolated switching converter 100 operates in CCM or DCM, and to provide a mode signal MS indicating the mode of operation of the switching converter 100. The mode detection circuit is configured to provide the mode signal MS by detecting if a current flowing through an energy storage component (e.g., the transformer T) crosses zero, and the current sense method comprises sensing a current flowing through the secondary winding of the transformer T, sensing a current flowing through the secondary switch SR, or sensing a current flowing through an auxiliary winding (not shown in FIG. 1) of the transformer T, and so on. In addition, those skilled in the art will appreciate that embodiments described herein are merely exemplary implementations.

When the mode of operation of the isolated switching converter is detected at a secondary side, the isolation circuit 103 shown in FIG. 1 will be used. The isolation circuit 103 is configured to transfer the information indicating the mode of the operation from the secondary side to a primary side. In some embodiments, the isolation circuit 103 may comprise opto-coupler, transformer, capacitor or any other suitable electrical isolation device. In other embodiments, the isolation circuit 103 may be located outside of the controller 30.

The term “driving strength” may refer to the voltage and current levels, as well as temporal properties of the voltage and the current (e.g., ramp-up, ramp-down, and the like), which are used to drive the gate to operate the primary switch MP. These properties may be determined by adjusting the electrical circuits of the gate driver 102. In many cases the driving current reflects the driving strength. In the following description, the driving current, as an example, is considered to describe the different driving strength which is adaptive and switchable based on the different mode of the operation.

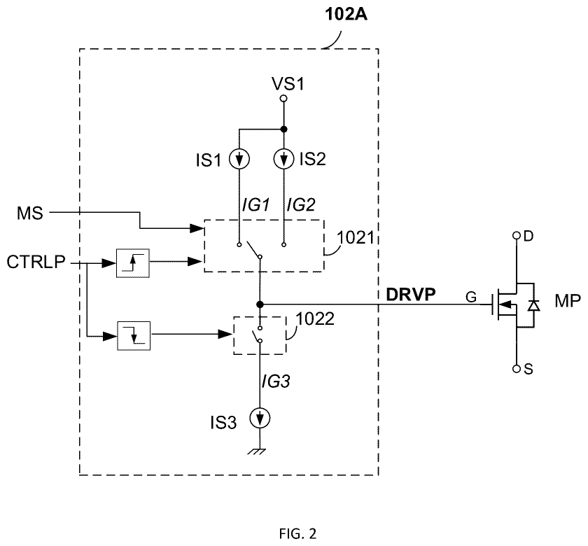

FIG. 2 shows a schematic diagram of a gate driver 102A in accordance with an embodiment of the present invention. As shown in FIG. 2, the gate driver 102A comprises driving current sources IS1 and IS2, a discharge current source IS3, a selective circuit 1021 and a discharge switch 1022. Based on the driving control signal DRVP applied to the control terminal (e.g., a gate terminal G) of the primary switch MP, the electrical connection between the first terminal (e.g., a drain terminal D) of the primary switch MP and the second terminal (e.g., a source terminal S) of the second terminal of the primary switch MP is controlled.

In the embodiment shown in FIG. 2, the driving current sources IS1 and IS2 both have a power supply terminal and an output terminal, wherein the power supply terminals of the driving current sources IS1 and IS2 are both coupled to a supply voltage terminal VS1. The output terminal of the driving current source IS1 is configured to provide a first driving current IG1. The output terminal of the driving current source IS2 is configured to provide a second driving current IG2. Wherein the first driving current IG1 is lower than the second driving current IG2. In one embodiment, the first driving current IG1 is set to one-fifth of the second driving current IG2.

In the embodiment shown in FIG. 2, the selective circuit 1021 has a first input terminal, a second input terminal, a selecting control terminal, an enable terminal and an output terminal. The first input terminal of the selective circuit 1021 is coupled to the output terminal of the driving current source IS1. The second input terminal of the selective circuit 1021 is coupled to the output terminal of the driving current source IS2. The selecting control terminal of the selective circuit 1021 is coupled to receive the mode signal MS indicating the mode of the operation of the isolated switching converter. The enable terminal of the selective circuit 1021 is coupled to the primary control circuit 101 to receive the primary control signal CTRLP.

In the embodiment shown in FIG. 2, when the isolated switching converter 100 operates in DCM, the mode signal MS becomes the second level, when the isolated switching converter 100 operates in CCM, the mode signal MS becomes the first level. In one embodiment, the first level is a logic high level, and the second level is a logic low level. In other embodiments, the values of the first level and the second level may vary with the applications. Accordingly, the corresponding logic circuits are also adjusted adaptively.

When a rising edge of the primary control signal CTRLP comes, in response to the mode signal MS indicating CCM, the selective circuit 1021 selects the first driving current IG1 to drive the gate of the primary switch MP, so as to charge the gate voltage of the primary switch MP, the driving control signal DRVP is configured to have the first driving strength. In DCM, the second driving current IG2 is selected to drive the gate of the primary switch MP, to charge the gate voltage of the primary switching MP, and the driving control signal DRVP is configured to have the second drive strength.

In addition, in the embodiment shown in FIG. 2, the discharge switch 1022 has a first terminal, a second terminal and a control terminal. The first terminal of the discharge switch 1022 is coupled to the gate of the primary switch MP. The control terminal of the discharge switch 1022 is coupled to receive the primary control signal CTRLP. The discharge current source IS3 has a first terminal and a second terminal, wherein the first terminal is coupled to the second terminal of the discharge switch 1022, the second terminal is coupled to the primary reference ground. When a falling edge of the primary control signal CTRLP comes, the discharge switch 1022 is turned on to provide a discharging path. The discharge current source IS3 provides the discharge current IG3, the gate voltage of the primary switch MP decreases, and the primary switch MP is turned off quickly.

Even though the gate driver 102A shown in FIG. 2 takes the driving current as the example to describe the working principle of the gate driver 102A with different driving strength. In other embodiments, the gate driver 102A may adjust other driving parameters of the driving control signal DRVP to configure the voltage and current levels, as well as temporal properties of the voltage and the current. Other driving parameters may comprise the ramp up speed of the gate voltage, or the rising time of the gate voltage. In other embodiments, the driving strength of the gate driver 102A can be weakened by connecting resistors to the driving path or disabling part of driving electrical circuits.

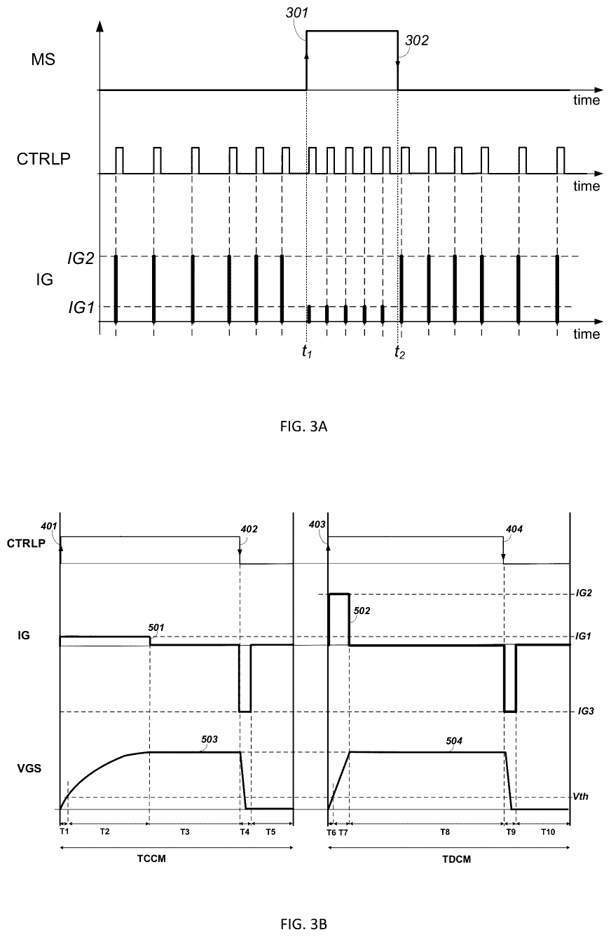

FIG. 3A shows a working waveform of the gate driver 102A shown in FIG. 2 in accordance with an embodiment of the present invention. As shown in FIG. 3A, the mode signal MS, the primary control signal CTRLP, and the driving current IG in the gate driver 102A are respectively shown from top to bottom. The driving current IG is an example of the one or more driving parameters, which can be switched between the first driving current IG1 and the second driving current IG2 in different modes of the operation. Wherein the first driving current IG1 is lower than the second driving current IG2.

In the embodiment shown in FIG. 3A, before time t1, the mode signal MS becomes the low level, the isolated switching converter 100 operates in DCM. In response rising edges of the primary control signal CTRLP, the driving current IG provided by the gate driver 102A keeps at the second driving current IG2, and the gate driver 102A is configured to have the second driving strength.

At time t1, a rising edge 301 of the mode signal MS comes, which indicates that the switching converter 100 enters CCM, the driving current IG provided by the gate driver 102A is switched to be the lower first driving current IG1, and thus the second driving strength is weakened to be the first driving strength. During the time duration from time t1 to time t2, in response to the rising edges of the primary control signal CTRLP, the gate driver 102A is configured to charge the gate of the primary switch MP with the lower first driving current IG1 to turn on the primary switch MP.

At time t2, a falling edge 302 of the mode signal MS comes, which indicates that the switching converter 100 exits CCM and enters into DCM. The gate driver 102A is configured to charge the gate of the primary switch MP with the second driving current IG2, and thus the first driving strength is adjusted to be the stronger second driving strength.

FIG. 3B shows a working waveform of the gate driver 102A shown in FIG. 2 in accordance with another embodiment of the present invention. The waveform diagrams of the gate driver 102A during two switching periods referred to as TCCM for CCM and TDCM for DCM are respectively shown in FIG. 3B. The switching periods TCCM and TDCM are each divided in several time segments. In the example show in FIG. 3B, the switching period TCCM is divided in five time segments labelled from T1 to T5. The switching period TDCM is also divided in five time segments labelled from T6 to T10. The driving current IG is labelled as 501 for CCM and is labelled as 502 for DCM, respectively. The schematic profiles of the gate voltage VGS of the primary switch MP, which is labelled as 503 for CCM and labelled as 504 for DCM.

In the embodiment shown in 3B, during the switching period TCCM, the switching converter 100 operates in CCM, the driving control signal DRVP provided the gate driver 102A is configured to have the first driving strength. In detail, in response to a rising edge 401 of the primary control signal CTRLP, the driving current IG is switched to be the lower driving current (e.g., the first driving current IG1). During the time segments T1 and T2, the driving current IG is clamped and maintained at the first driving current IG1, to slowly turn on the primary switch MP. Wherein during the time segment T1, the gate voltage VGS of the primary switch MP slowly increases from an initial voltage to a threshold voltage Vth. During the time segment T2, the gate voltage VGS continues to increase from the threshold voltage Vth up to a target voltage by the charging the gate of the primary switch MP with the first driving current IG1. During the time segment T3, the gate of the primary switch MP is fully charged and the target voltage is maintained, and the driving current IG backs to the initial value. During the time segment T4, in response to a falling edge 402 of the primary switch MP, the driving current IG is replaced by a discharging current IG3, to discharge the gate voltage VGS of the primary switch MP, and thus the primary switch MP is turned off. During the time segment T5, the primary switch MP keeps off, until the next switching period in CCM.

In the example shown in FIG. 3B, when the switching converter 100 operates in DCM, the driving control signal DRVP is switched to have the second driving strength. As shown in FIG. 3B, during the switching period TDCM, in response to a rising edge 403 of the primary control signal CTRLP, the driving current IG is switched to the higher driving current (e.g., the second driving current IG2). During the time segments T6 and T7, the driving current IG is maintained at the second driving current IG2, to quickly turn on the primary switch MP. Wherein during the time segment T6, the gate voltage VGS of the primary switch MP quickly increases from the initial voltage to the threshold voltage Vth. During the time segment T7, the gate voltage VGS quickly increases from the threshold voltage Vth up to the target voltage. Compared with the time segments T1 and T2 in CCM, the time segments T6 and T7 in DCM are shorter, and thus the primary switch MP can be turned on and turned off quickly in DCM.

Similarly, during the time segment T8, the gate of the primary switch MP is fully charged, the target voltage is maintained and the driving current IG backs to the initial value. During the time segment T9, in response to a falling edge 404 of the primary control signal MP, the driving current IG is replaced by the discharging current IG3, to discharge the gate voltage VGS of the primary switch MP, and thus the primary switch MP is turned off. During the time segment T10, the primary switch MP keeps off until the next switching period in DCM.

In the example shown in FIG. 3B, in DCM, the gate driver 102A configured to have a strong driving strength is used to drive the primary switch MP. The gate driver 102A used in DCM may provide enough current or voltage in order to reach the required gate voltage VGS relatively quickly. In contrast, in CCM, the gate driver 102A configured to have a weak driving strength is used to drive the primary switch MP, and may provide lower current or voltage. In one embodiment, the gate driver 102A in CCM is configured to hold a driving parameter at a relatively lower value. In another embodiment, the gate driver 102A in CCM with the weak strength is configured to reach the required gate voltage VGS relatively slowly.

According to the embodiments, a fast and strong gate driver is used in DCM in order to provide the higher driving strength to the gate of the primary switch MP, in order to minimum switching time and high efficiency. Wherein the switching time refers the time that the primary switch MP changes its status from ON to OFF or from OFF to ON. A slow or weak gate driver for CCM results in the reduction of the noise and the improvement of the reliability.

In addition, the USB (Universal Serial Bus) PD (Power Delivery) standard has started gaining popularity among smart devices and notebook computer manufacturers. The USB PD standard allows for a higher power level (up to 100 W) and adaptive output voltages (e.g., form 5V to 28V), this trend requires higher power, faster and smaller isolated switching converters.

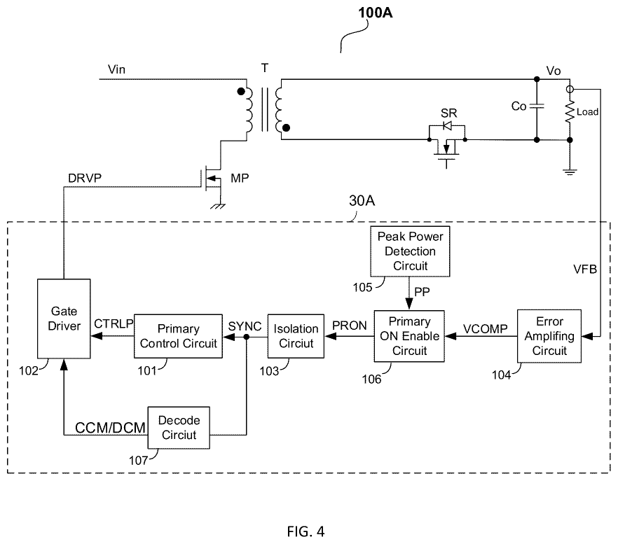

FIG. 4 shows a schematic diagram of an isolated switching converter 100A in accordance with an embodiment of the present invention. The isolated switching converter 100A may be configured to operate in DCM during normal operation, in order to meet low to mid power demand (e.g., less than 100 w), while the isolated switching converter 100A may also be configured to operate in CCM when a peak power mode is enabled, in order to meet a peak power demand (e.g., higher than 100 w).

As shown in FIG. 4, the isolated switching converter 100A comprises a transformer T, a primary switch MP, a secondary switch SR and a controller 30A. In the example shown in FIG. 4, the controller 30A comprises a primary control circuit 101, a gate driver 102, an isolation circuit 103, an error amplifying circuit 104, a peak power detection circuit 105, a primary ON enable circuit 106 and a decode circuit 107.

In the example shown in FIG. 4, the peak power detection circuit 105 is configured to provide information indicating if the peak power mode is enabled, and the information is transmitted through the isolation circuit 103 from the secondary side to the primary side of the isolated switching converter 100A. The gate driver 102 is configured to receive the information indicating if the peak power mode is enabled, based on the received information to determined the mode of the operation of the isolated switching converter 100A to be CCM or DCM, and accordingly the driving control signal DRVP is controlled to have the first driving strength or the second driving strength.

When the peak power mode of the switching converter 100A is enabled, the mode of the operation is determined to be CCM, and the switching converter 100A enters into CCM, to provide higher current and power for the load. A peak value of a current flowing through the primary switch MP during peak power mode is higher than that of the current flowing through the primary switch MP during the normal operation (or DCM). Therefore, when the peak power mode is enabled and the isolated switching converter 100A enters into CCM, the gate driver 102 is configured to decrease the driving strength by supplying the lower driving current to charge the gate of the primary switch MP. The decrease of the driving strength results in the decrease of the switching loss, the improved efficiency, as well as the reduction of the spike in peak power mode, and thus to improve the reliability of the primary switch MP.

The term “spike” may refer to a sudden increase in voltage and/or current due to transient energy release in a circuit. It is understood that the spike may also be associated with a sharp increase in transient voltage, current, power, energy, and so on. The voltage spike may have a direct negative impact on device reliability, and the current spike may exceed the electro-migration stress, may convert the spike energy into electromagnetic interference. Therefore, the gate driver 102 with the weak driving strength is used in CCM, such that a maximum rated voltage of the primary switch MP, for example the gate voltage VGS, is not exceeded by transient voltage and/or current spikes (e.g., overshoots, undershoots, ringing, and/or the like).

Furthermore, in the example shown in FIG. 4, the error amplifying circuit 104 is configured to receive a feedback signal VFB representative of an output voltage Vo of the switching converter 100A. The error amplifying circuit 104 is configured to amplify the difference between the feedback signal VFB and a reference voltage, and to provide a compensation signal VCOMP.

The primary ON enable circuit 106 has a first input terminal, a second input terminal and an output terminal. The first input terminal of the primary ON enable circuit 106 is coupled to the peak power detection circuit 105 to receive an indication signal PP. The indication signal PP is configured to indicates if the peak power mode is enabled. The second input terminal of the primary ON enable circuit 106 is coupled to the error amplifying circuit 104 to receive the compensation signal VCOMP. Based on the compensation signal VCOMP and the indication signal PP, the primary ON enable circuit 106 is configured to provide a primary ON enable signal PRON at the output terminal. The primary ON enable signal PRON is configured to control switching frequency of the primary switch MP. In this embodiment, the primary ON enable signal PRON also comprises the information indicating if the peak power mode is enabled. In one embodiment, the frequency of the primary ON enable signal PRON depends on the compensation signal VCOMP. In some embodiments, the primary ON enable signal PRON is a pulse signal, and the pulse width or duty cycle of the pulse signal depend on the indication signal PP.

The isolation circuit 103 has an input terminal and an output terminal. The input terminal of the isolation circuit 103 is configured to receive the primary ON enable signal PRON. The output terminal of the isolation circuit 103 is configured to provide a synchronous signal SYNC electrically isolated from the primary ON enable signal PRON. The decode circuit 107 is coupled to the output terminal of the isolation circuit 103 to receive the synchronous signal SYNC, and is configured to decode the synchronous signal SYNC to obtain the information indicating if the peak power mode is enabled, in order to determine if the switching converter 100A to enter CCM. The primary control circuit 101 is also couple to the output terminal of the isolation circuit 103 to receive the synchronous signal SYNC, and based on the synchronous signal SYNC, the primary control circuit 101 provides the primary control signal CTRLP to control the turning-on and turning-off of the primary switch MP.

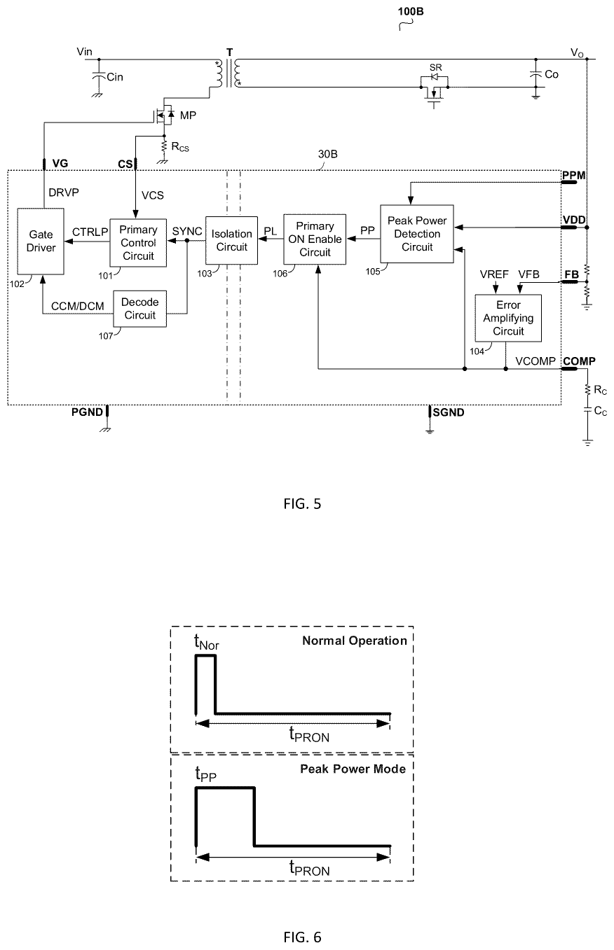

FIG. 5 shows a schematic diagram of an isolated switching converter 100B in accordance with an embodiment of the present invention. In the example shown in FIG. 5, the isolated switching converter 100B comprises a transformer T, a primary switch MP, a secondary switch SR and an integrated control circuit 30B.

In the example shown in FIG. 5, the integrated control circuit 30B comprises the primary control circuit 101, the gate driver 102, the isolation circuit 103, the error amplifying circuit 104, the peak power detection circuit 105, the primary ON enable circuit 106 and the decode circuit 107 shown in FIG. 4, and further comprises a plurality of pins. The plurality of pins comprise a secondary power supply pin VDD, an output feedback pin FB, a compensation pin COMP, a secondary reference ground pin SGND, a primary current sense pin CS, a primary control pin VG, and a primary reference ground pin PGND.

In the example shown in FIG. 5, the circuits located in the primary side and the secondary side are all integrated in a monolithic enclosure referred as the integrated control circuit 30B. in some embodiments, the controller 30B and the secondary switch SR are integrated in an integrated circuit to provide a driver circuit for the secondary switch SR.

In the example shown in FIG. 5, the error amplifying circuit 104 has a first input terminal, a second input terminal and an output terminal. The first input terminal of the error amplifying circuit 104 is coupled to the output feedback pin FB to receive a feedback signal VFB representative of an output voltage Vo of the switching converter 100B. The second input terminal of the error amplifying circuit 104 is configured to receive a reference voltage VREF. The output terminal of the error amplifying circuit 104 is coupled to the compensation pin COMP to provide the compensation signal VCOMP.

In one example, the peak power detection circuit 105 is coupled to the secondary power supply pin VDD, to receive the output voltage Vo of the switching converter 100B. Based on the output voltage Vo and the compensation signal VCOMP, the peak power detection circuit 105 is configured to provide the indication signal PP indicating if the peak power mode is enabled at the output terminal. In one embodiment, when the output voltage Vo exceeds a first threshold voltage VH1 and the compensation signal VCOMP is higher than the second threshold voltage VH2, the indication signal PP becomes logic high level from logic low level, this indicates that the peak power mode is enabled.

In one example, the integrated control circuit 30B further comprises a peak power enable pin PPM. The peak power enable pin PPM may configure the power demand by connecting an external resistor located outside of the integrated control circuit 30B, or by coupling to a PD controller. The peak power detection circuit 105 is configured to provide the indication signal PP based on a status at the peak power enable pin PPM. The status at the peak power enable pin PPM may comprises a logic high level, a zero level (coupled to a reference ground), and/or floating. In one embodiment, when the peak power enable pin PPM is floating, the peak power mode is disabled. When the peak power enable pin PPM becomes zero level from the floating status, the peak power mode is enabled. In a further embodiment, when the voltage at the peak power enable pin PPM maintains the zero level and the maintaining time exceeds a predetermined time period, the peak power mode is enabled.

The primary ON enable circuit 106 is coupled to the peak power detection circuit 105 to receive the information indicating if the peak power mode is enabled, and this information is encoded into the primary ON enable signal PRON. The primary ON enable signal PRON with the information is transmitted from the secondary side to the primary side through the isolation circuit 103. The gate driver 102 receives this information indicating if the peak power mode is enabled, and controls the driving control signal DRVP to have the first driving strength or the second driving strength.

In addition, the primary current sense pin CS is coupled to a current sense resistor Rcs to sense a current flowing through the primary switch MP, and provides a current sense signal VCS. The current sense resistor Rcs is coupled in series with the primary switch MP. The primary control circuit 101 has a first input terminal, a second input terminal and an output terminal. The first input terminal of the primary control circuit 101 is coupled to the current sense pin CS to receive the current sense signal VCS. The second input terminal of the primary control circuit 101 is coupled to the output terminal of the isolation circuit 103 to receive the synchronous signal SYNC. Based on the synchronous signal SYNC and the current sense signal VCS, the primary control circuit 101 provides the primary control signal CTRLP at the output terminal, to control the primary switch MP.

FIG. 6 shows working waveforms of a primary ON enable signal under normal operation and a peak power mode in accordance with an embodiment of the present invention. As shown in FIG. 6, during the normal operation, the primary ON enable signal PRON has a first pulse width t_{Nor}. When the peak power mode is enabled, the primary enable signal PRON is configured to have a second pulse width tₚₚ which is longer than the first pulse width t_{Nor}. The synchronous signal SYNC is electrically isolated from the primary ON enable signal PRON, and thus have the same pulse widths for normal operation or the peak power mode. As a result, the information indicating if the peak power mode is enabled that is transmitted from the secondary side to the primary side. In one embodiment, the primary ON enable signal PRON is configured to control the switching frequency of the primary switch MP. A period t_{PRON} (or the frequency) of the primary ON enable signal PRON depends on the compensation signal VCOMP.

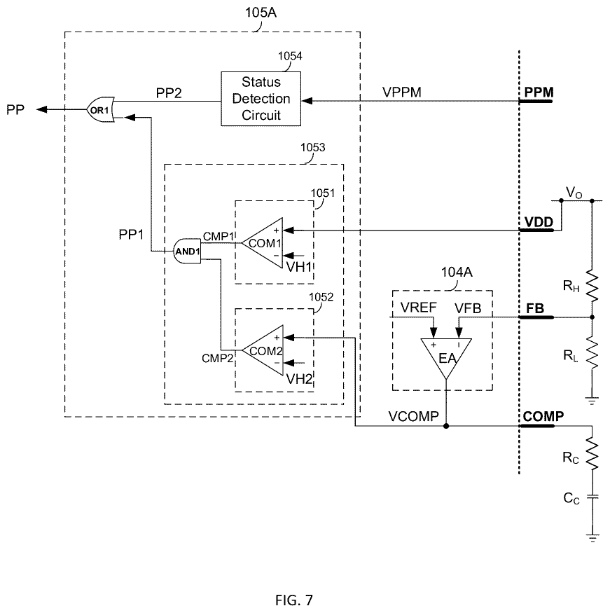

FIG. 7 shows a circuit diagram of an error amplifying circuit 104A and a peak power detection circuit 105A in accordance with an embodiment of the present invention. In the example shown in FIG. 7, the error amplifying circuit 104A comprises an error amplifier EA. The inverting input terminal of the error amplifier EA is configured to receive the feedback signal VFB, the non-inverting input terminal is configured to receive the reference voltage VREF, the output terminal is configured to provide the compensation signal VCOMP.

In the example shown in FIG. 7, the peak power detection circuit 105A comprises two detection paths, to provide two different ways for enabling the peak power mode. A first detection path comprises a first comparison circuit 1051, a second comparison circuit 1052, and a AND gate circuit AND1. The first comparison circuit 1051 has a first input terminal, a second input terminal and an output terminal, wherein the first input terminal receives the output voltage Vo, the second input terminal receives the first threshold voltage VH1. The first comparison circuit 1051 compares the output voltage Vo with the first threshold voltage VH1, and provides a first comparison signal CMP1 at the output terminal based on the comparison result. The first comparison circuit 1051 comprises a comparator COM1. The non-inverting input terminal of the comparator COM1 is coupled to the secondary power supply pin VDD, the inverting input terminal of the comparator COM1 receives the first threshold voltage VH1. The output terminal of the comparator COM1 provides the first comparison signal CMP1.

The second comparison circuit 1052 has a first input terminal, a second input terminal and an output terminal, wherein the first input terminal receives the compensation signal VCOMP, the second input terminal receives the second threshold voltage VH2, the second comparison circuit 1052 compares the compensation signal VCOMP with the second threshold voltage VH2, and provides a second comparison signal CMP2 at the output terminal based on the comparison result. The second comparison circuit 1052 comprises a comparator COM2. The non-inverting input terminal of the comparator COM2 is coupled to the compensation pin COMP to receive the compensation signal VCOMP. The inverting input terminal of the comparator COM2 receives the second threshold voltage VH2. The output terminal of the comparator COM2 provides the second comparison signal CMP2. The AND gate circuit AND1 has a first input terminal, a second input terminal and an output terminal. The first input terminal of the AND gate circuit AND1 receives the first comparison signal CMP1. The second input terminal of the AND gate circuit AND1 receives the second comparison signal CMP2. And the output terminal of the AND gate circuit AND1 provides an indication signal PP1.

A second detection path comprises a status detection circuit 1054. The status detection circuit 1054 is configured to provide an indication signal PP2 based on the status at a peak power enable pin PPM. In one embodiment, the peak power enable pin PPM can communicate with a PD controller to receive the peak power enable demand.

Referring still to FIG. 7, the OR gate circuit OR1 has a first input terminal, a second input terminal and an output terminal. The first input terminal receives the indication signal PP1, the second input terminal receives the indication signal PP2, and the OR gate circuit OR1 provides the indication signal PP.

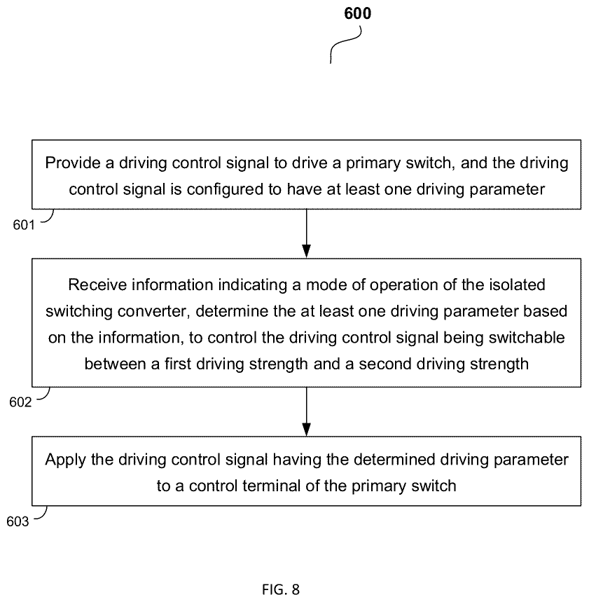

FIG. 8 shows a flow diagram of a control method 600 used in an isolated switching converter in accordance with an embodiment of the present invention. The isolated switching converter comprises a transformer having a primary winding and a secondary winding, and a primary switch coupled to the primary winding. As shown in FIG. 8, the control method 600 comprises steps 601˜603.

At step 601, a driving control signal is provided to drive the primary switch. The driving control signal has at least one driving parameter.

At step 602, information indicating a mode of the operation of the isolated switching converter is received. Based on the received information, the at least one driving parameter is determined to control the driving control signal to being switchable between a first driving strength and a second driving strength.

At step 603, the driving control signal with the determined driving parameter is applied to a control terminal of the primary switch. When the isolated switching converter operates in CCM, the driving control signal is controlled to have the first driving strength, and when the isolated switching converter operates in DCM, the driving control signal is controlled to have the second driving strength stronger than the first driving strength.

In one embodiment, the control method 600 further comprises the following steps. At a secondary side, information indicating the mode of the operation of the switching converter is provided. The provided information is sent to an isolation circuit. At a primary side, the information indicating the mode of the operation of the switching converter is received through the isolation circuit.

In another embodiment, the switching converter operates in DCM during the normal operation, and exits DCM to operate in CCM when the peak power mode is enabled.

In one embodiment, detecting if the peak power mode is enabled comprises the following steps. A feedback signal representative of an output voltage of the switching converter is provided. The difference between the feedback signal and a reference voltage is amplified and a compensation signal is provided. When the output voltage of the switching converter increases to a first threshold voltage and the compensation signal is higher than a second threshold voltage, the peak power mode of the switching converter is enabled.

In another embodiment, detecting if the peak power mode is enabled comprises: the peak power mode is not enabled in response to a first status at a peak power enable pin of an integrated circuit, and the peak power mode is enabled in response to a second status at the peak power enable pin. In one embodiment, the first status refers the peak power enable pin is floating, and the second status refers to the peak power enable pin is grounded.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A controller used in an isolated switching converter having a transformer and a primary switch, the controller comprising:
a gate driver configured to provide a driving control signal for driving the primary switch and to receive information indicating a mode of operation of the isolated switching converter, the driving control signal is controlled to being switchable between a first driving strength and a second driving strength based on the information, and wherein when the isolated switching converter operates in a continuous conduction mode (CCM), the driving control signal is controlled to have the first driving strength, and when the isolated switching converter operates in a discontinuous conduction mode (DCM), the driving control signal is controlled to have the second driving strength stronger than the first driving strength.

2. The controller of claim 1, wherein the driving control signal is configured to have driving parameters, the driving parameters comprise at least one of a driving current, a driving voltage, a rising slope, a rising time and a gate driver impedance.

3. The controller of claim 1, wherein:
the driving control signal is controlled to have the first driving strength by adjusting one driving parameter to be a first value; and
the driving control signal is controlled to have the second driving strength by adjusting the one driving parameter to be a second value higher than the first value.

4. The controller of claim 1, wherein the isolated switching converter operates in DCM during normal operation, and switches to operate in CCM from DCM when a peak power mode is enabled.

5. The controller of claim 1, further comprising:
a peak power detection circuit configured to receive information indicating if a peak power mode is enabled, to generate an indication signal based on the information, and to transmit the information from a secondary side to a primary side through an isolation circuit; and
a decode circuit configured to receive the information indicating if the peak power mode is enabled through the isolation circuit, and to determine if the isolated switching converter to enter CCM.

6. The controller of claim 5, further comprising:
an error amplifying circuit having a first input terminal, a second input terminal and an output terminal, wherein the first input terminal is configured to receive a feedback signal representative of an output voltage of the isolated switching converter, the second input terminal is configured to receive a reference voltage, based on the difference between the feedback signal and the reference voltage, the error amplifying circuit provides a compensation signal at the output terminal;
a primary ON enable circuit coupled to the peak power detection circuit to receive the indication signal, and further configured to receive the compensation signal, based on the compensation signal and the indication signal, the primary ON enable circuit provides a primary ON enable signal to an input terminal of the isolation circuit, and the primary ON enable signal contains the information indicating if the peak power mode is enabled; and
a primary control circuit coupled to an output terminal of the isolation circuit to receive a synchronous signal electrically isolated from the primary ON enable signal, based on the synchronous signal, the primary control circuit provides a primary control signal to control the primary switch through the gate driver; and wherein
the decode circuit is coupled to the output terminal of the isolation circuit to receive the synchronous signal and is configured to decode the synchronous signal to obtain the information indicating if the peak power mode is enabled.

7. The controller of claim 6, wherein the synchronous signal has a first pulse width when the peak power mode is disabled, and the synchronous signal is adjusted to have a second pulse width longer than the first pulse width when the peak power mode is enabled.

8. The controller of claim 5, wherein the peak power detection circuit comprises:
a first comparison circuit configured to compare the output voltage of the isolated switching converter with a first threshold voltage and to provide a first comparison signal based on the comparison;
a second comparison circuit configured to compare the compensation signal with a second threshold voltage and to provide a second comparison signal based on the comparison; and
a AND gate circuit configured receive the first comparison signal and the second comparison signal, and to provide the indication signal.

9. The controller of claim 5, further comprising a peak power enable pin, the peak power detection circuit provides the indication signal based on a status at the peak power enable pin.

10. An isolated switching converter, comprising:
a transformer, having a primary winding and a secondary winding;
a primary switch coupled to the primary winding; and
a controller comprising a gate driver configured to provide a driving control signal for driving the primary switch, the gate driver is configured to receive information indicating a mode of operation of the isolated switching converter, the driving control signal is controlled to being switchable between a first driving strength and a second driving strength based on the information, and wherein when the isolated switching converter operates in CCM, the driving control signal is controlled to have the first driving strength, and when the isolated switching converter operates in DCM, the driving control signal is controlled to have the second driving strength stronger than the first driving strength.

11. The isolated switching converter of claim 10, wherein the driving control signal is configured to have driving parameters, the driving parameters comprise at least one of a driving current, a driving voltage, a rising slope, a rising time and a gate driver impedance.

12. The isolated switching converter of claim 10, wherein the driving control signal is controlled to have the first driving strength by adjusting one driving parameter to be a first value, and the driving control signal is controlled to have the second driving strength by adjusting the one driving parameter to be a second value higher than the first value.

13. The isolated switching converter of claim 10, wherein the isolated switching converter operates in DCM during normal operation, and switches to operate in CCM from DCM when a peak power mode is enabled.

14. The isolated switching converter of claim 13, wherein the controller further comprising:
a peak power detection circuit configured to receive information indicating if the peak power mode is enabled, and to transmit the information from a secondary side to a primary side through an isolation circuit; and
a decode circuit configured to receive the information indicating if the peak power mode is enabled through the isolation circuit, and to determine if to operate the isolated switching converter to enter CCM.

15. A control method used in an isolated switching converter having a transformer and a primary switch, comprising:
providing a driving control signal for driving the primary switch, wherein the driving control signal is configured to have at least one driving parameter;
receiving information indicating a mode of operation of the isolated switching converter, and based on the information, determining the at least one parameter to control the driving control signal being switchable between a first driving strength and a second driving strength; and
applying the drive control signal having the determined driving parameter to a control terminal of the primary switch, wherein when the isolated switching converter operates in CCM, the driving control signal is controlled to have the first driving strength, and when the isolated switching converter operates in DCM, the driving control signal is controlled to have the second driving strength stronger than the first driving strength.

16. The control method of claim 15, wherein the at least one driving parameter comprises at least one of a driving current, a driving voltage, a rising slope, a rising time, and a gate driver impedance.

17. The control method of claim 15, wherein:
adjusting one driving parameter to be a minimum value to make the driving control signal have the first driving strength; and
adjusting the one driving parameter to be a maximum value to make the driving control signal have the second driving strength, wherein the second value is higher than the first value.

18. The control method of claim 15, further comprising:
providing information indicating if a peak power mode is enabled and sending the information to an isolation circuit; and
receiving the information indicating if the peak power mode is enabled through the isolation circuit at a primary side.

19. The control method of claim 18, wherein the isolated switching converter operates in DCM during normal operation, and switches to operate in CCM from DCM when the peak power mode is enabled.

20. The control method of claim 18, wherein enabling the peak power mode comprising:
providing a feedback signal representative of an output voltage of the isolated switching converter;
providing a compensation signal based on the feedback signal and a reference voltage; and
when the output voltage increases to a first threshold voltage and the compensation signal is higher than a second threshold voltage, the peak power mode is enabled.
